(19) United States
(12) Patent Application Publication
(10) Pub. No.: US 2010/0121700 A1
(43) Pub. Date: May 13, 2010

(54) SYSTEM AND METHOD FOR INCENTIVE-BASED RESOURCE CONSERVATION

(76) Inventors: David Wigder, Bronx, NY (US); Ron Gonen, New York, NY (US)

Correspondence Address: MALDJIAN & FALLON LLC, 365 BROAD STREET, THIRD FLOOR, RED BANK, NJ, 07701, US

(21) Appl. No.: 12/692,090

(22) Filed: Jan. 22, 2010

Related U.S. Application Data
(63) Continuation-in-part of application No. 11/345,867, filed on Feb. 2, 2006.
(60) Provisional application No. 61/146,521, filed on Jan. 22, 2009.
(60) Provisional application No. 61/236,190, filed on Aug. 24, 2009.

(51) Int. Cl. G06Q 50/00; G06Q 30/00; G06Q 10/00

(52) U.S. Cl. 705/14.25; 705/30

(57) ABSTRACT

Embodiments of the present invention generally relate to a system and method for administering an incentive-based program to encourage environmentally-conscious behavior. In one embodiment, a method for administering an incentive-based program to encourage environmentally-conscious behavior comprises providing a network-accessible database, hosted by an administrator, having a plurality of sets of records, each set of records corresponding to a user, monitoring an environmentally-conscious behavioral activity of a first user, and recording a record of the behavioral activity in the database, using a computer-based mathematical calculation to translate the record of the behavioral activity to a value, and storing the value within a record of a set of records corresponding to the first user, and allowing the first user to access the database, using a computing device to communicate through a data portal to the database via a network, to redeem the value for a credit at a third party retailer.

### CROSS-REFERENCE TO RELATED APPLICATIONS

This application is a continuation-in-part of U.S. patent application Ser. No. 11/345,867, filed Feb. 2, 2006, which claims the benefit of U.S. Provisional Patent Application Ser. No. 60/650,610, filed Feb. 7, 2005, the disclosures of which are incorporated herein by reference in their entireties. This application also claims priority to U.S. Provisional Patent Application Ser. No. 61/146,521, filed Jan. 22, 2009, entitled “System and Method for Incentive-Based Resource Conservation,” and to U.S. Provisional Patent Application Ser. No. 61/161,698, filed Mar. 19, 2009, entitled “Marketplace System and Method for Waste Reduction,” the disclosures of which are incorporated herein by reference in their entireties.

### BACKGROUND

1. Field of the Invention

Embodiments of the present invention generally relate to a system and method for administering an incentive-based program to encourage environmentally-conscious behavior. More specifically, embodiments of the present invention relate to a system and method of providing incentives and rewards to encourage individuals, businesses, and other entities to reduce or minimize the use of non-sustainable natural resources, to limit consumption of vital resources (e.g., water, energy, etc.) and to conduct themselves in behavior patterns and daily activities which result in an increased benefit to the environment.

2. Related Art

Due to mounting global concerns about the state of the environment, it has become necessary for consumers and producers alike to adopt a more eco-friendly lifestyle. In order to preserve vital natural resources, such as water and energy, consumers need to exercise discretion and utilize these resources in moderation and only when necessary. Similarly, the production of energy from the combustion of fossil fuels (i.e., coal, oil, natural gas, etc.) and other renewable and nonrenewable natural resources generally results in the production of carbon dioxide and other harmful greenhouse gases.

On the consumer's side, the average individual can implement a number of resource-saving practices, such as turning off lights when leaving a room, turning off a water faucet when not in use, purchasing water or energy saving devices and recycling and reusing, reusable goods. Producers can implement similar resource-conserving practices, including recycling of reusable goods and utilizing heat reclamation techniques in connection with manufacturing processes. However, historically, a majority of consumers and producers have not actively implemented and participated in these conservation activities, in part, because there is no effective motivation or incentive to do so. As a result, we find ourselves in a world of rapidly-deteriorating natural resource stockpiles, whose disappearance threatens the way in which we live our everyday lives, now and into the future.

Many campaigns and other public advocacy programs have been launched throughout the years in an effort to motivate the average consumer to increase recycling efforts and minimize consumption of resources. These programs typically attempt to persuade individuals by informing them of the potential environmental and economic effects of disposing of recyclable goods and consuming large amounts of water and energy. However, historically, some of these programs produce a minute and ephemeral effect, while others produce no visible effect at all.

In another attempt to solve such problems, many federal, state, and local governments and public utilities grant incentives to individuals, businesses, or other entities which install resource-saving equipment in their place of residence or business. These incentives may include tax credits, tax rebates, property tax reductions, sales tax reductions or exemptions for purchases of resource-saving equipment, rebates on utility bills (such as water, heat, or electricity) and rebates on or vouchers toward the purchase of water- or energy-saving devices. However, many of these incentives are available to individuals or businesses after the equipment has been bought and installed—that is to say, even after an entity buys and installs water- and/or energy-saving equipment, it is not a guarantee that the entity will qualify to receive a tax incentive or whether that incentive is sufficient to motivate enough people to make the investment over time to reach conservation goals. If the entity completes the installation of the equipment and does not qualify for or receive a tax incentive, the entity has lost the capital cost of the equipment with little to no hope of ever being reimbursed. They also do not address long-term behavior change independent of investments in capital equipment.

In yet another attempt to solve the problem solved by the invention disclosed herein, many federal, state, and local governments, public utilities and even some private corporations, provide individuals and businesses who wish to install resource-saving equipment with the opportunity for obtaining a loan to offset the capital cost of purchasing and installing the equipment. For example, a loan may be available to an individual or business who desires to install photovoltaic modules in order to curb energy costs. However, such loans are typically medium- to long-term loans (about 10 to 15 years, but may be as high as 40 years) and may have interest rates which may exceed 17%. This latter loan arrangement also can be somewhat ineffective in motivating consumers to make environmentally friendly choices.

In addition to the problems with energy conservation, a significant amount of environmental waste could be eliminated through greater consciousness by consumers regarding the choices that they make in their daily lives, including purchase decisions and waste disposal options. For example, consumers can make a positive impact on the environment when they purchase a used product versus new, shift from paper-based to online billing statements, use a digital versus printed version of a book, or rent a designer pocketbook versus buying a new one, etc. However, beyond an improved intrinsic feeling of self-worth or gratification for the knowledge that such an activity helps the environment, or perhaps a slight discount for purchasing “pre-owned” goods, there is no motivation for a consumer to capitalize on the positive impact such environmentally conscious behavior creates.

Thus, there is a need for a system and method of providing incentives and rewards to encourage individuals, businesses, and other entities to limit consumption of vital resources (e.g., water, energy, etc.) and to conduct themselves in behavior patterns and daily activities which result in an increased benefit to the environment.

### SUMMARY

Embodiments of the present invention generally relate to a system and method for administering an incentive-based program to encourage environmentally-conscious behavior. More specifically, embodiments of the present invention relate to a system and method of providing incentives and rewards to encourage individuals, businesses, and other entities to reduce or minimize the use of non-sustainable natural resources, to limit consumption of vital resources (e.g., water, energy, etc.) and to conduct themselves in behavior patterns and daily activities which result in an increased benefit to the environment.

In one embodiment of the present invention, a method for administering an incentive-based program to encourage environmentally-conscious behavior comprises providing a network-accessible database, hosted by an administrator, having a plurality of sets of records, each set of records corresponding to a user, monitoring an environmentally-conscious behavioral activity of a first user, and recording a record of the behavioral activity in the database, using a computer-based mathematical calculation to translate the record of the behavioral activity to a value, and storing the value within a record of a set of records corresponding to the first user, and allowing the first user to access the database, using a computing device to communicate through a data portal to the database via a network, to redeem the value for a credit at a third party retailer.

In another embodiment of the present invention, a method of administering an incentive-based utility conservation program comprises monitoring a first entity's utility usage data over a predetermined time interval using a measuring and recording means, and reporting the utility usage data to an administrator, comparing utility usage data to a predetermined limit, determining whether the utility usage data satisfied the predetermined limit, and subsequently converting the utility usage data to a value, and storing the value in a database record, the database record comprising a cumulative value of values accumulated by the first entity, permitting the first entity to access a data portal through a network, using a computing device, to redeem the value for a credit at a third party participating retailer, wherein the cumulative value comprises a plurality of values, each value acquired by the first entity through a plurality of environmentally-conscious behavioral activities.

In yet another embodiment of the present invention, a method for administering an incentive-based program to encourage environmentally-conscious behavior comprises establishing a marketplace system, the marketplace system comprising: a computer accessible network, a plurality of consumers, a plurality of merchants, and an administrator, having a database in communication with the network for overseeing transactions between any one of the plurality of consumers and any one of the plurality merchants, monitoring a commercial transaction between a first consumer of the plurality of consumers and one of the plurality merchants, storing data regarding the transaction in the database, using a computer-based mathematical calculation to translate the data to a value, and storing the value within a record in the database corresponding to the first consumer, and allowing the first consumer to access the database, using a computing device to communicate through a data portal to the database via the computer accessible network, to redeem the value for a credit at a third party retailer, wherein the commercial transaction comprises an environmentally-conscious behavioral activity.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a system for administering an incentive-based program to encourage environmentally-conscious behavior in accordance with one embodiment of the present invention;

FIG. 2 depicts a block diagram of a general purpose computer system in accordance with one embodiment of the present invention;

FIG. 3 depicts a flowchart of an exemplary method in accordance with one embodiment of the present invention;

FIG. 4 depicts a general representation of a marketplace system to encourage environmentally-conscious behavior in accordance with one embodiment of the present invention; and

FIG. 5 depicts a flowchart of an exemplary method in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to a system and method for incentive-based resource conservation. More specifically, embodiments of the present invention relate to a system and method of providing incentives and rewards to encourage individuals, businesses, and other entitles to limit consumption of or structurally change the demand for vital resources (e.g., water, energy, etc.).

As used herein, “environmentally-conscious behavior” or “eco-friendly behavior,” and variations and derivates thereof, shall mean a conscious undertaking by an entity or individual for a principal purpose of benefiting the environment as a whole. Environmentally-conscious behavior shall include active steps taken by an entity to minimize or avoid the use of non-sustainable natural resources, reduce energy, commodity or utility consumption, to reuse or recycle consumer goods, or the like. For example, embodiments of the present invention provide incentive for environmentally-conscious behavior, actions or activities, and shall include any method or system designed or intended: to encourage the reduction or sustainable use of natural resources (e.g., trees, water); to reduce or minimize resource use or actions that contribute to global warming (e.g., reduce fossil fuel consumption); to increase use of renewable resources or actions that lessen our global warming impact (e.g., increase renewable energy, increase use of mass transit/ride sharing/car sharing); to reduce, reuse, recycle or properly dispose of waste; to encourage the purchase of goods and services that help reduce natural resource use or lessen impact on global warming (e.g., purchase used product vs. buying new, rent/share products vs. purchase, buy digital vs. physical products, purchase energy- or water-saving products, wash cars at car wash that uses less water or recycles water, etc.); to properly dispose of organic materials (e.g., food waste and/or yard waste); or to conduct themselves in behavior patterns and daily activities which result in an increased benefit to the environment.

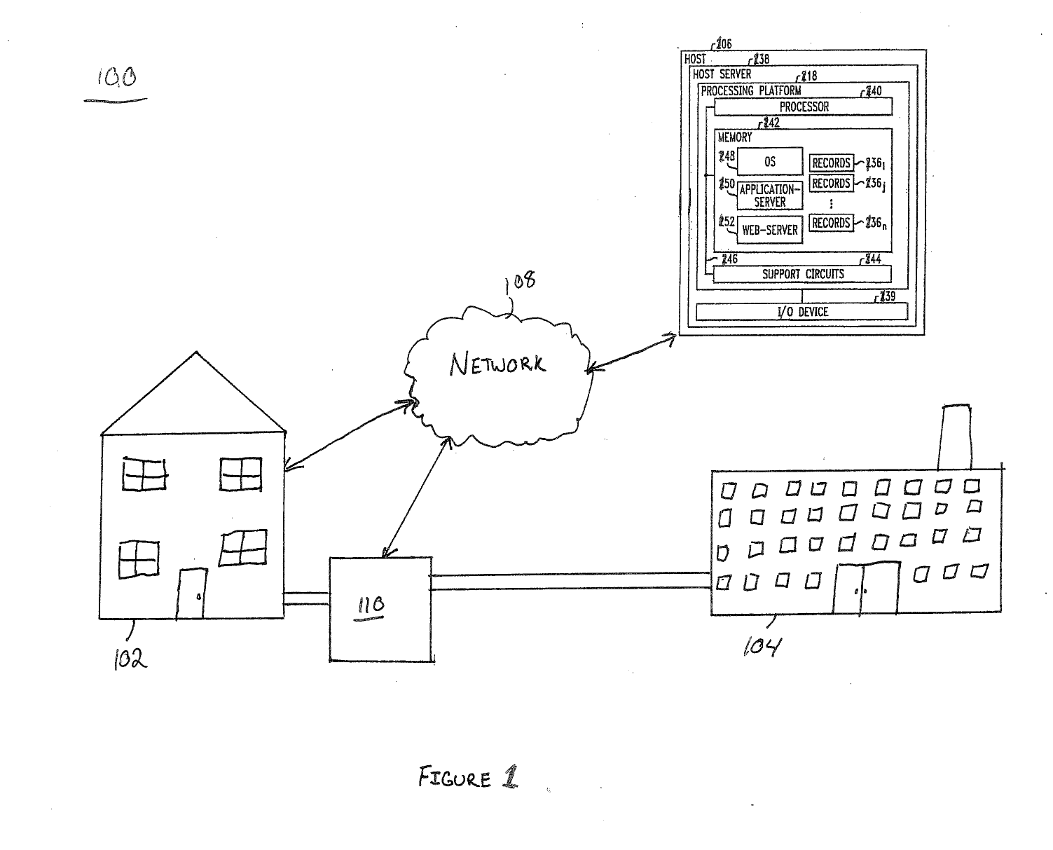

FIG. 1 depicts a system for administering an incentive-based program to encourage environmentally-conscious behavior in accordance with one embodiment of the present invention. In accordance with one embodiment of the present invention, a system 100 for incentive-based resource conservation generally comprises an entity 102 (e.g., a customer, residence, business, or the like), a supplier 104 (e.g., a resource supplier, a utility company, an energy source, a water reservoir, etc.), a host 106, a network 108, and a measuring device 110.

The entity 102 may include any number of individuals, business, households, residences, apartment complexes, etc., in accordance with various embodiments of the present invention. In essence, an entity 102 may comprise a categorization of any person, business, or the like, which is capable of utilizing a conservable resource.

The supplier 104 may include any number of resource providers, including, but not limited to: utility companies, energy source providers, water source provider, energy management companies, water management companies, a government agency (municipal, local, state or federal), or the like.

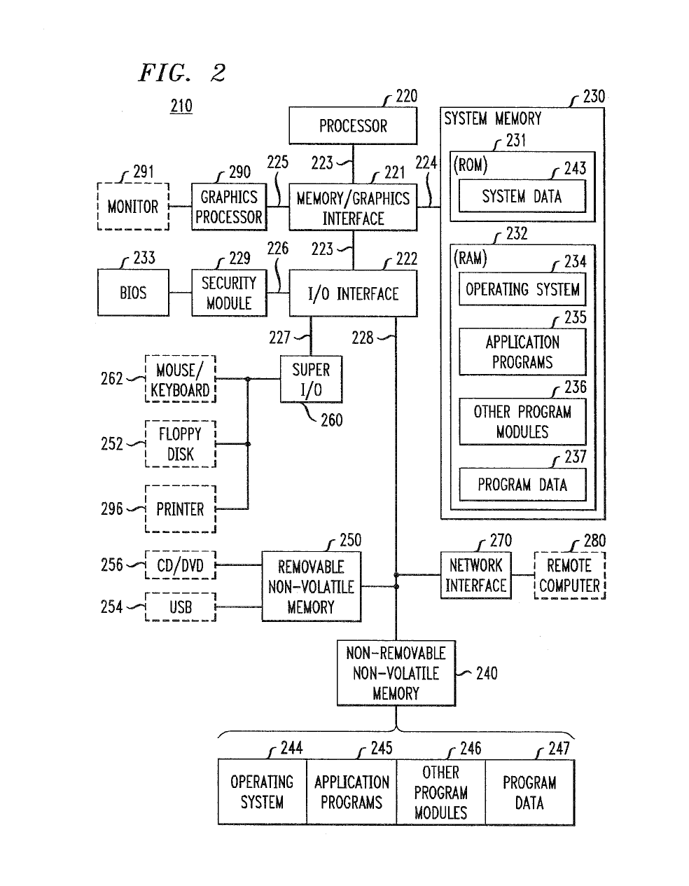

The host 106 may include an administrator comprising one or more servers, including a host server 138. The host server 138 may be deployed in one or more general purpose computers (for example, as shown in FIG. 2) or specialty purpose computers, personal computers, mainframes, minicomputers, server-type computers and/or any a processor-based platform that operates on any suitable operating system, such as Microsoft®, Windows® and/or Linux; and capable of executing software and/or a plurality of executable instructions.

The host server 138 may include a large number of elements; most of which are not shown in the general purpose computer of FIG. 2 for simplicity of exposition. The elements of host server 138 may be formed in a single unitary device and concentrated on a single server, client, peer or other type node. Alternatively, the elements of the host server 138 may be formed from two or more separate devices, and as such, may be distributed among a number of server, client, peer or other type nodes.

The host server 138 may be deployed in accordance with the scale-up and/or scale-out approaches. Using the scale-up approach, the host server 138 may increase its processing power, amount of memory and number of networkable connections by utilizing a symmetrical, multi-processor architecture so as to provide additional capacity. A benefit of this scale-up approach is that such approach provides for simplified configuration and management as compared to the scale-out approach. Using the scale-out approach, the host server 138 may increase its processing power, amount of memory and number of networkable connections by incrementally adding and/or removing capacity as needed, balancing workload across multiple processors, multiple servers, dedicating specific processors and/or servers for performing specific tasks, using physical or logical servers (e.g., a multi-node cluster approach), etc.

As shown, the host server 138 includes one or more processing units (collectively “processor”) 140, memory 142, supports circuits 144 and bus 146. The processor 140 may be one or more conventional processors, microprocessors, multi-core processors, microcontrollers and the like.

The bus 146 provides for transmissions of digital information among the processor 140, memory 142 and support circuits 144 and other (not shown) portions of the host server 138. The support circuits 144 facilitate operation of the processor 140, and may include well-known circuitry or circuits, including, for example, one or more input/output I/O interfaces; one or more NIUs; cache; clock circuits; power supplies and the like.

The I/O interface provides an interface to control the transmissions of digital information among (shown and not shown) components of host server 138. In addition, the I/O interface provides an interface to control the transmissions of digital information among I/O devices 139 associated with or otherwise attached to the host server 138. The I/O devices 139 may be embodied as any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, and (vii) a pointing device, such as a mouse, joystick, trackball, touchpad, pointing stick, light pen, head pointer, soap mouse, eye tracking devices, digitizing tablet and stylus, data glove that translates the user's movements to computer gestures; (vii) a key-in device, such as a keyboard or a touchpad, (viii) and the like.

The NIUs facilitate exchange (e.g., sending and/or receiving) of content. Accordingly, the NIUs may be adapted for communicating over terrestrial wireless, satellite, and/or wireline media.

The memory 142 may be or employ random access memory, read-only memory, optical storage, magnetic storage, removable storage, erasable programmable read only memory and variations thereof, content addressable memory and variations thereof, flash memory, disk drive storage, removable storage, any combination thereof, and the like. The memory 124 may store and/or receive requests from the processor 140 to execute various software packages, such as operating system 148, application-server software 150 and web-server software 152.

Additionally, the memory 142 may store and/or receive requests from the processor 140 to obtain records 136.sub.i-136.sub.n (e.g., copies thereof). As above, each of the records 136.sub.i-136.sub.n may be stored as or in a single file or a plurality of files, and may be structured as text, a table, a database, a distributed hash table, a distributed concurrent object store, a document formed using a markup or markup-like language, and the like. The records 136.sub.i-136.sub.n may be stored, for example, using a Microsoft SQL Server and accessible through an ODBC connection.

Like the records 136.sub.i-136.sub.n, the memory 142 may store and/or receive requests from the processor 140 to obtain operands, operators, dimensional values, configurations, and other data that are used by the various software packages to control the operation of and/or to facilitate performing the functions of the host server 138 and/or the host 106.

The application-server software 150, when executed by the processor 140, is operable to (i) communicate with the measuring device 110 via the network 108, to obtain the record 136.sub.j; and (ii) determine a value associated with the measurement from the measuring device 110. In addition, the application-server software 150, when executed by the processor 140, is operable to associate the value to a credit, which may be redeemable by the entity 102; post the credit to the credit to a user account associated with the entity (“entity account”) 102; and provide the web-server software 152 with access to the entity account.

In many embodiments, the application-server software 150, when executed by the processor 140, organizes a plurality of values generated from the entity, through its environmentally-conscious behavior activities. For example, in one embodiment, a value may be generated by monitoring a reduction in energy consumption of the entity over a set time period, and such value is stored by the host 106. In the same exemplary embodiment, the entity may also generate a value by virtue of its curbside recycling activity, for example, as disclosed in co-pending U.S. patent application Ser. No. 11/345,867, the disclosure of which is incorporated by reference herein in its entirety, and such value is also stored by the host 106. Accordingly, in certain embodiments of the present invention, the entity 102 may generate value through a variety of environmentally-conscious behavior, wherein each environmentally-conscious behavioral task accumulates a value, which may be collectively stored by the host 106 for future credit redemption by the entity 102.

The web-server software 152, when executed by the processor 140, is operable provide on one or more web pages to allow the entity to access the entity account, and in turn, the credit and other information associated with the recycling activities. For example, web-server software 152 may post the credit on the web pages that are accessible by the entity, so as to enable the entity to view details of the entity account. The details of the entity account may include the credit (and/or previously accrued credits) associated with the resource conservation (and/or previously deposited) material, dates associated with the environmentally-conscious activities, quantities of the activity and (previously conducted activity) over a given period of time; debits from the credit (and/or previously accrued credits), detailed history of spending of the credit (and/or previously accrued credits), any orders for vouchers for redeemed credits, and the like.

In addition, the web-server software 152, when executed by the processor 140, is operable to allow the entity 102 to redeem the credit. This may include the web-server software 152 providing a portal to third party retailers to allow the entity to redeem the credit (and/or previously accrued credits) at the retailers to obtain goods, services, coupons valued for goods or services, other benefits or discounts, and the like. In certain embodiments, rather than redeeming the credit directly with the retailers, the web-server software 152 may work in conjunction with software provided by the retailers to enable the entity 102 to redeem the credit.

The web-server software 152 may also be operable to allow the entity to transform the credit (and/or previously accrued credits) into one or more vouchers that may be spent at the participating retailers, donated to some other entity, or other entity managed transaction. To facilitate this, the web-server software 152 includes code to allow the entity to (i) order the vouchers for delivery by mail, email or other communication medium; (ii) provide information to the entity to allow the entity to print or otherwise reduce to physical form, store it on the electronic medium or a peripheral device (e.g., a PDA, memory device, etc.); or (iii) immediately use the voucher in an electronic form for redemption at the third party retailer.

The network 108 may be a partial or full deployment of most any communication/computer network or link, including any of, any multiple of, any combination of or any combination of multiples of a public or private, terrestrial wireless or satellite, and wireline networks or links. The network 108 may include, for example, network elements from a Public Switch Telephone Network (“PSTN”), the Internet, core and proprietary public networks, wireless voice and packet-data networks, such as 1G, 2G, 2.5G and 3G telecommunication networks, wireless office telephone systems (“WOTS”) and/or wireless local area networks (“WLANs”), including, Bluetooth and/or IEEE 802.11 WLANs, wireless personal area networks (“WPANs”), wireless metropolitan area networks (“WMANs”) and the like; and/or communication links, such as Universal Serial Bus (“USB”) links; parallel port links, Firewire links, RS-232 links, RS-485 links, Controller-Area Network (“CAN”) links, and the like.

The network elements and/or communication links may include circuit-switched as well as packet-data elements to provide transport of content, triggers and/or other information; and may be configured to communicate such information using any number of protocols and in any manner consistent with exchanging such information among the entity 102, the host 106 and the measuring device 110. These protocols may include standardized, proprietary, open-source, and freely-available communication protocols for communicating content in circuit-switching and/or packet data networks, and the like.

The measuring device 110 may include any quantitative measuring apparatus, capable of monitoring an entity's usage or consumption of a resource, suitable for embodiments of the present invention. In one embodiment, the measuring device 110 comprises an industry-standard meter, generally installed by the supplier 104 in the ordinary course of business, typically at a location outside the home or at the supplier's facilities. For example, in one embodiment, where the supplier 104 comprises an electric company, the measuring device 110 may comprise a standard energy meter, measuring an entity's energy in Kilowatt hours, or the measuring device 110 may comprise energy management devices at the point of use within the home, also measuring an energy use in Kilowatt hours. In another embodiment, where the supplier 104 comprises an oil or natural gas company, the measuring device may comprise a standard energy meter, measuring an entity's energy in BTUs. In another embodiment, where the supplier 104 comprises a water distribution facility, the measuring device 110 may comprise a standard flow meter, monitoring the volume of water delivered to the entity 102. In another embodiment, where the supplier 104 comprises a water distribution facility, the measuring device 110 may comprise water management flow meter at the point of use within the home, monitoring the volume of water delivered to the entity 102.

In another embodiment, the measuring device 110 may comprise a plurality of devices, for example, located at each point of use within the entity 102 including, but not limited to, appliances, light fixtures, electrical outlets, furnaces, water heaters and water faucets and spigots. In such embodiments, it may be feasible to ascertain which appliance, fixture, etc., may be operating inefficiently and causing a waste of resources.

As understood with embodiments of the present invention, a measuring device 110 may comprise a combination of any of above, including for example, a general water meter outside the home, and a meter at each individual faucet within the home. Any plausible number of individual devices may be utilized at the entity 102 without departing from the nature and scope of the present invention.

In certain embodiments, the measuring device 110 may be the same device utilized by the relevant utility company or service provider. In such an embodiment, it may not be practical to duplicate efforts of the utility company and/or service provider, and accordingly, the measuring device 110 may be shared between the host 106 and the utility company.

In many embodiments, in addition to a quantitative measuring apparatus, the measuring device 110 may comprise a reporting means, in communication with the host 106, through the network 108. In one embodiment, the reporting means comprises a general computer system (for example, as shown in FIG. 2) or other similar computer mechanism. In many embodiments, the reporting means is capable of updating the host with usage information of a particular resource being monitored by the measuring device 110. Often, the reporting means will provide the host 106 with updated usage information on an automated periodic schedule (e.g., weekly, monthly, etc.) In some embodiments, the reporting means requires manual intervention. For example, the reporting means may require a member of the entity (i.e., homeowner, business manager, etc.) activate the upload of measurement data to the host 106, by engaging at least a portion of the reporting means and instructing it to provide such data to the host 106.

In alternative embodiments, the reporting means is separable from the measuring device 110. In such embodiments, the reporting means may include a personal computer, a telephone, a mobile device, or the like, whereby the entity is responsible for manually updating the host with the measurement data from the measuring device 110, or the host 106 may send an agent or employee on its behalf to the entity 102 to obtain the measurement data from the measuring device 110.

In further embodiments, particularly where the measuring device 110 is shared between the host 106 and a utility company or service provider, the reporting means may include a software application which effectively pulls data from the utility company or service provider. In some embodiments, the reporting means may comprise a direct data pull or “scraping” from a database hosted by the utility company. In another embodiment the reporting means may comprise reports or data files provided by the utility company to assist the host 106 in encouraging the users to engage in environmentally-conscious behavior.

As discussed above, any of the computing devices of the system 100 may comprise a general computing device, for example, as shown in the form of a computer 210 depicted in FIG. 2. Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components, including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of “legacy” peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 2, or any combination of one or more of such elements, in order to perform the necessary functions of the embodiments of the present invention.

It is understood by embodiments of the present invention that a computer, such as the one depicted in FIG. 2, may be connected to a computer network or system. A computer network includes the Internet, a global computer network, an internal computer network, dedicated server networks, and the like.

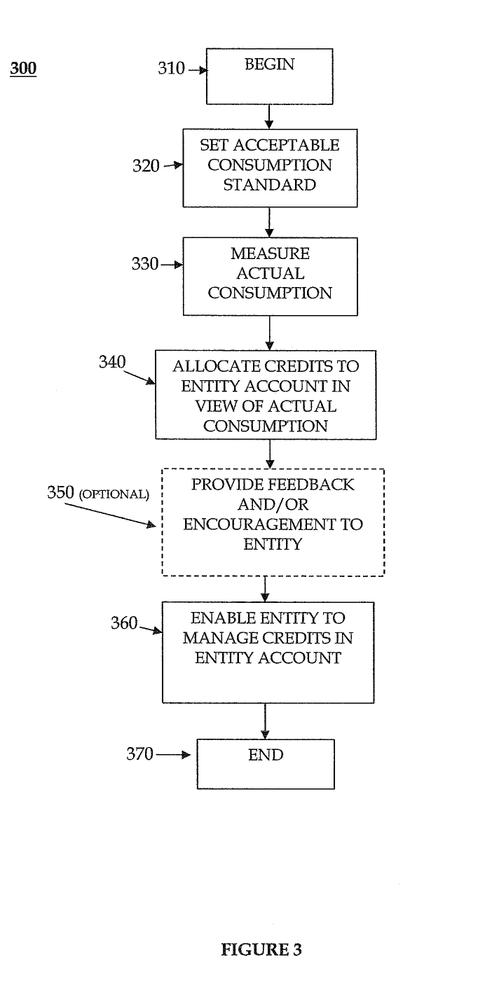

FIG. 3 depicts a flowchart of an exemplary method in accordance with one embodiment of the present invention. Where possible, reference is made herein to the system 100 depicted in FIG. 1. In accordance with the exemplary embodiment, the method 300 begins at step 310.

At step 320, an acceptable consumption standard is set for the entity 102. In one embodiment of the present invention, the acceptable consumption standard is set by the supplier 104. For example, involving a water conversation model, a municipal water facility may monitor monthly or quarterly household consumption of water in a certain geographical area. The municipal water facility may estimate, using its expert knowledge in the industry, that a typical household using a reasonable effort to cut back on water usage should only consume about XXX hundred cubic feet (HCFs) of water per quarter. As such, the acceptable consumption standard may be provided as XXX HCFs per quarter, or (⅓)XXX HCFs per month.

In another embodiment, the acceptable consumption standard may provided as entity-specific, that is, each entity's usage is compared against its usage from a similar previous time period or compared against its usage from a previous time period and adjusted for temperature and moisture level changes and other factors that affect resource use differences. For example, if an entity 102 utilized YYY kWh of energy during the month of July in year one, the acceptable consumption standard for the entity 102 in July in year two may be 90% of YYY kWh. In a similar example, if the entity 102 utilizes about ZZZ CFs of water during the first quarter of the year (i.e., January-March), the acceptable consumption standard may be 95% of ZZZ CFs for the second quarter of the year (i.e., April-June).

At step 330, the actual resource consumption of the entity 102 is measured. In one embodiment, the measuring device 110 obtains a measurement of the specific resource consumption, generally over a particular time interval. As discussed supra, often the measuring device 110 comprising a reporting means. In one embodiment, the reporting means connects with the host 106, through the network 108, and updates the records 136ᵢ₋ₙ with the necessary data for the entity 102. In another embodiment, the reporting means requires a manual intervention (e.g., a telephone call-in program to the host, a data entry portal available through the Internet, etc.). In such an embodiment, the entity 102 may be required to obtain a measurement of resource consumption (often provided as a cumulative numerical value of consumption over a significant period of time—from which a particular measurement can be obtained by comparing to a previous measurement and taking a tare value). The entity 102 may then have to type, message, discuss, or otherwise relay such measurement to the host 106.

At step 340, the actual resource consumption is compared to the acceptable consumption standard, and if the entity conserved sufficient resources, a reward/credit may be allocated to the entity's account stored with the host 106. Such rewards may comprise direct monetary rewards, indirect monetary rewards (e.g., coupons, credits, gift certificates), redeemable “units,” or any combination thereof. As used herein, the term “unit” and any derivative term thereof may refer to any unit which may serve as a unit of account, a store of value, and a medium of exchange. A unit may comprise currency, token(s), ticket(s), point(s), any other unit feasible in the context of the present invention, or any combination thereof, and may be redeemable for direct or indirect monetary or value-based rewards. The rewards may be allocated electronically (e.g., a transaction between two bank accounts, an entry into an electronic database), physically (e.g., a check or money order, a certificate), or by any other method feasible in the context of the present invention.

In one embodiment of the present invention, rewards are allocated to an entity 202 in an amount which is proportionate to a basic (e.g., raw measurement) or derived (e.g., mean value(s), median value(s)) parameter or value obtained from an entity's actual resource consumption measurement in view of the acceptable consumption standard. In such an embodiment, the amount of rewards allocated to any entity may be calculated or otherwise determined using at least an algorithm or a set of algorithms, and may be provided in an amount commensurate with a reduction amount of resource consumption (e.g., one reward point for every one kWh reduced) An algorithm may take as input any of the measurements made or data points recorded before, during, or after collection of actual resource consumption measurement from an entity 102, or any statistical value derived therefrom. The output of an algorithm may be a specific currency amount, an amount of points or tokens, a credit amount, a number of units, or the like.

In another embodiment of the present invention, rewards are allocated to an entity in a fixed amount, contingent upon meeting or surpassing a particular goal. In such an embodiment, the entity's actual resource consumption measurement is compared to the acceptable consumption standard, or to community data (e.g., consumption is lower than a group average), etc. If so, the entity may be credited with a fixed amount of rewards (e.g., one reward unit for meeting or surpassing the acceptable consumption standard.) In another embodiment, an entity may be credited with a fixed amount of units regardless of the trend in actual resource consumption measurements, but for merely participating in the program.

In yet another embodiment of the present invention, rewards may be allocated to an entity for purchasing a resource-saving products (e.g., water-saving toilets, flow-reducing showerheads, energy-efficient air conditioning and heating units, front-loading washing machines, energy-efficient light bulbs, etc.). Furthermore, rewards may be distributed to an entity for performing resource-conserving repairs and home improvements (e.g., adding insulation, replacing furnace fueled with oil heat with one that burns natural gas) and services (e.g., hire plumber to fix leaky toilet, etc) or enlist a company or individual to do the same.

Rewards may also be distributed to an entity in any amount and at any time in accordance with one embodiment of the present invention. Additionally, in accordance with another embodiment of the present invention, an entity may be barred from receiving more than a predetermined amount of rewards during a predefined period of time. For example, an entity may not be able to receive more than a certain number of points during a single year. In such an embodiment, any additional points which would have been earned by an entity who has already earned the maximum allowable amount of points may be donated, ignored, deferred to the next period of time in which the entity would be allowed to earn those points, or otherwise handled.

However, if an entity's actual resource consumption measurement reveals the entity's resource usage has increased rather than decreased, the entity may receive no rewards, fewer rewards, or negative rewards (e.g., rewards removed).

At optional step 350, a host may provide feedback and/or encouragement to the entity for attempting to reduce resource consumption, for actually doing so, or for failing to do so. In one embodiment, the host 106 may also comprise a messaging system. In various embodiments, the messaging system may utilize a number of forms, including electronic (e.g., Instant Messaging (IM), e-mail, SMS/text messages, etc.), physical (e.g., letters, postcards, billing statements, etc.), automated telephonic message, or the like.

In accordance with one embodiment of the present invention, the messaging system may send messages to an entity to provide information and/or data regarding resource consumption, account/rewards information, subscription information, or the like. In accordance with one embodiment, the messaging system may be utilized to provide positive and/or negative reinforcement to entities to encourage and incentivize resource consumption reduction and discourage excessive usage. For example, if an entity's actual resource consumption data shows a decline in usage relative to an earlier point in time, or if the entity's actual resource consumption data is below a group or community average, a message may be sent to the entity with message content designed to positively reinforce the reduction in usage (e.g., “Great job! Your household water consumption is below the city average!”). In another situation, if an entity's actual resource consumption data shows an increase in usage relative to an earlier point in time, or if the entity's resource consumption data is above a group or community average, a message may be sent to the entity with message content designed to negatively reinforce the increase in usage and to persuade the entity to reduce their consumption of resources (e.g., “Your household water consumption is more than your neighbors'.”, “Earn valuable rewards for reducing your household water consumption!”).

In accordance with yet another embodiment of the present invention, the messaging system may be utilized in connection with advertising, marketing, and promotional materials for resource-saving products and services. For example, messages containing content such as, “Purchase a water-efficient dishwasher and earn rewards!”, “Fix a leaking toilet, save water and earn rewards!”, and “Earn double reward points when you purchase a water-saving product!” may be sent to an entity 102 in order to promote resource conservation and incentivize installation and usage of resource-saving equipment and appliances.

At step 360, the system enables the entity to manage the entity's account. Generally, included in the management of the entity account, is the entity's ability to engage in certain reward-based transactions, including, but not limited to: vendor redemption, auctions, sweepstakes, donations, transfers, and purchases (i.e., self-purchase or gift purchase).

In one embodiment, the entity is able to redeem the rewards associated with the entity account at a participating vendor. Each vendor may have a different value associated with a reward unit, and as such, each vendor may allow entities to redeem rewards in various ways. For example, some vendors may provide a reward to dollar association (e.g., 10 rewards equals up to 1 dollar value with the vendor), other vendors may provide a product to reward value (e.g., in exchange for 10 reward units, the entity receives one free widget), other vendors may provide an additional purchase value to the reward value (e.g., in exchange for 10 reward units, the entity may buy one get one free), and other vendors may provide a discount to reward value (e.g., 10% off entire purchase in exchange for 10 rewards). Other similar value scenarios may exist as well.

Generally, the vendor will provide a shopping forum either through an online store via a computer network or in a traditional retail store. If the entity wishes to redeem rewards with the vendor through an online store, access may generally be provided through a redemption link on the entity's account, hosted by the host 106, optionally working in conjunction with a server or software provided by a retailer. In some embodiments, however, it may be necessary for the entity to go to a website hosted by the vendor, and utilizing a virtual certificate, coupon, or similar identification code, and enter such code before redemption of rewards is allowed. In a traditional retail store environment, it is generally necessary for the user to print a physical coupon or certificate, having an identification code, and bring the coupon or certificate with the entity at the time of purchase/redemption.

In another embodiment, an entity 102 may be able to participate in an auction, a sweepstakes, donate rewards to a charitable organization (e.g., educational facility, non-profit group, or the like) or transfer rewards to another entity's account. In an additional embodiment, an entity 102 may also purchase additional rewards for the entity's own account or for another entity's account, using a credit card or other traditional payment means.

In accordance with yet another embodiment of the present invention, an entity 102 may have access to resource consumption data at any desired time. Accessible data may comprise the entity's own resource consumption data, the resource consumption data of others, statistical derivations of any set of resource consumption data (e.g., average, median, mode, variance, standard deviation), or the like. This data and information may be available to the entity 102 through the network 108, either on the entity's account, a general informational webpage on the host 106, through the messaging system discussed supra, or the like.

In another embodiment of the present invention, an entity 102 may be required to purchase a subscription to participate in one or more embodiments of the invention as described herein by paying a one-time or periodic subscription fee. The payment of such a fee may allow and entity to participate and, consequently, to obtain and/or redeem rewards. The method 300 ends at step 370.

### Example 1

The following Table 1 depicts a representation of how a system and method in accordance with embodiments of the present invention may be utilized to strongly incentivize entities to participate in the program, shown using Los Angeles Residential Water Consumption data from 2007.

### LA Residential Water Consumption (2007 Profile)

TABLE 1

| | |
|---|---|
| Residential customers: 473,000 | Water purchased from MWD: 295,500 AF |
| Total annual consumption: 242,000 AF | Total annual expense: $124,000,000 |
| Avg. annual consumption: 0.51 AF or 224 HCF | Residential share of expense: 42% |

Consumer Benefits

| % Reduction in | | Residential | RB Reward | | | % of Average |
|---|---|---|---|---|---|---|
| Residential | Water Saved | Savings | Points | RB Reward | Net HH value | Residential |
| Water Use | (HCF per HH) | (Annual) | Earned | Value (Annual) | (Annual) | Water Bill |
| 5% | 11.65 | $29.09 | 1,200 | $120 | $149.09 | 26% |
| 10% | 23.30 | $58.18 | 2,400 | $240 | $298.18 | 51% |
| 15% | 34.95 | $87.27 | 3,600 | $360 | $447.27 | 77% |

| | |
|---|---|
| Estimated Average Annual Water Bill | $581.83 |

Los Angeles Department of Water & Power Benefits

| | | | | Savings in | | | Savings as % |
|---|---|---|---|---|---|---|---|
| % Reduction in | | | Water Cost | Water Cost | | Net Cost | of Total |
| Residential | Water Saved | Water Saved | (from MWD | from MWD | RB Annual | Savings to LA | Operating |
| Water Use | (HCF per HH) | (HCF Total) | per HCF) | (per HH) | Fee (per HH) | (Total) | Costs |
| 5% | 11.65 | 5,510,715 | $0.56 | $6.53 | ($2.61) | $1,853,264 | 0.4% |
| 10% | 23.30 | 11,021,431 | $0.56 | $13.06 | ($5.22) | $3,706,827 | 0.7% |
| 15% | 34.95 | 16,532,146 | $0.56 | $19.59 | ($7.84) | $5,559,791 | 1.1% |

As shown in the Table, under the Consumer Benefits portion, a 5% reduction in residential water usage yields approximately 11.65 HCF/HH (hundred cubic feet per household) in reduction a year, which translates to almost $29.09 on an average water bill. However, using an embodiment of the system and methods disclosed herein, such savings of 11.65 HCF/HH translates to approximately 1,200 reward points earned to the entity's account. In this example, such reward points have an actual retail value in savings of approximately $120.00. Thus, the household would save $29.09 in actual cost savings and earn $120.00 in reward value, in a single year. In view of an average annual household water bill costing $581.83, the overall value to the household for a 5% reduction is about a 26% overall savings from the standard water bill. As shown in the Table, when a household reduces the water consumption by 15%, it translates to about a 77% percent savings from the standard water bill. A complete return may be obtained at around a 20% reduction in annual water usage.

As shown in the Los Angeles Department of Water & Power Benefits portion, a 5% reduction of overall residential water usage yields the city a savings of over $1.8M, whereby the city subsidizes a significant portion of the overall city water usage. This 5% reduction saves the city nearly half a percent of its overall operating costs.

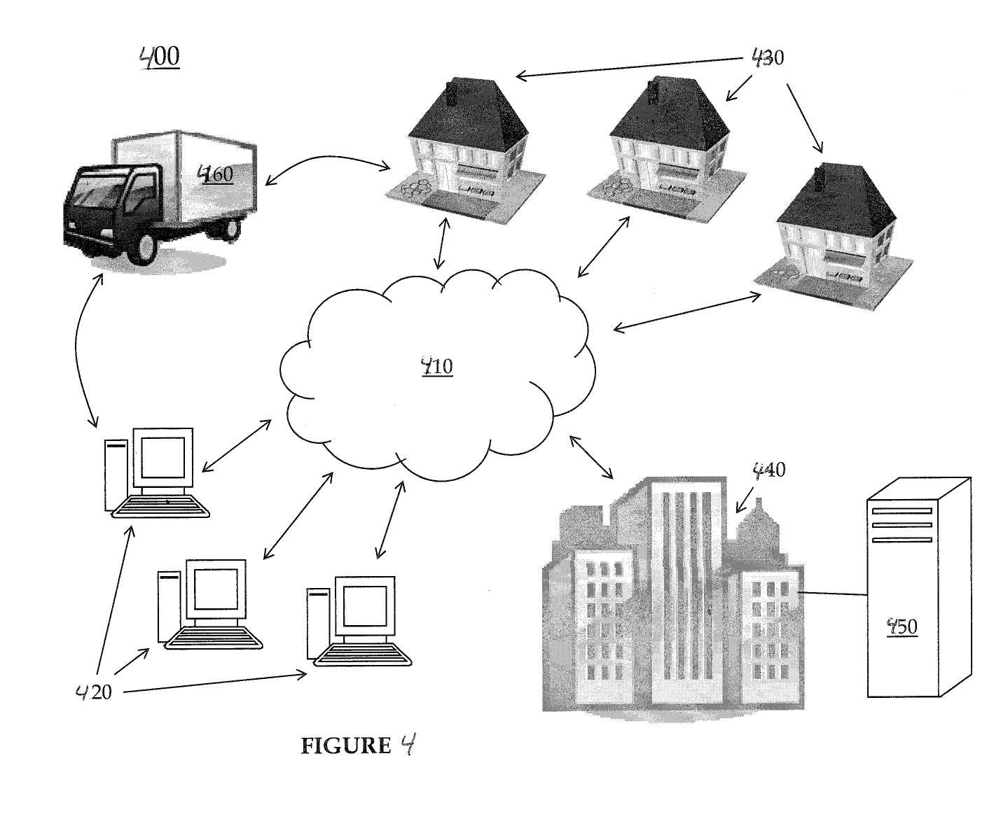

FIG. 4 depicts a general representation of a marketplace system to encourage environmentally-conscious behavior in accordance with one embodiment of the present invention. Generally, the marketplace system 400 comprises a network 410, a plurality of consumers 420, and a plurality of merchants 430. In many embodiments, the marketplace system further comprises an administrator 440 for overseeing the environmentally-conscious behavior and transactions that may occur between the consumers 420 and the merchants 430. The administrator may optionally comprise a database 450 connected to the network 410, which may store information and data regarding the consumers 420, the merchants 430 and any transactions there between.

The network 410 may comprise any network suitable for embodiments of the present invention. For example, the network 410 may be a partial or full deployment of most any communication/computer network or link, including any of, any multiple of, any combination of or any combination of multiples of a public or private, terrestrial wireless or satellite, and wireline networks or links. The network 410 may include, for example, network elements from a Public Switch Telephone Network (PSTN), the Internet, core and proprietary public networks, wireless voice and packet-data networks, such as 1G, 2G, 2.5G and 3G telecommunication networks, wireless office telephone systems (WOTS) and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

The plurality of consumers 420 may comprise any number of consumers suitable for embodiments of the present invention, with as few as one, or as many as may be supported by the system 400 and methods disclosed herein. The consumers 420 may comprise or be representative of any individual, group, organization, business, corporation, or the like. In many embodiments, consumers 420 may comprise an electronic device for communication through the network 410 to at least one of the merchants 430. In several embodiments, the electronic device comprises a computer system, for example, the general computer system of FIG. 2.

Additionally, although one marketplace system 400 is depicted in FIG. 4, the present invention contemplates that the marketplace system 400 may also represent a network of marketplaces that may be further networked together. By way of analogy, the marketplace system 400 may represent a galaxy, which is its own contained and sustainable system within a universe of marketplaces. The marketplace system 400 may be one of many self-contained marketplaces that are then connected within a multi-marketplace network.

The merchants 420 may comprise any number of merchants suitable for embodiments of the present invention, with as few as one, or as many as may be supported by the system 400 and methods disclosed herein. Each merchant within the plurality of merchants 420 may comprise any type of goods or service provider, for profit or not-for-profit, including manufacturers, importers, retailers, wholesalers, financial institutions, utility or commodity businesses, or the like.

In accordance with embodiments of the present invention, each merchant may sell or provide an environmentally-conscious good or service through the marketplace system 400. Environmentally-conscious goods or services may include, for example, a recycled or recyclable product, a used or reusable product, a rented product, a “green product,” a product having minimal packaging (i.e., reduction in standard material waste for product distribution), existence of non-toxic or non-harmful chemicals used in a good or service, a product, good or service that provides subsequent benefits to the environment (e.g., home weatherization products or retrofitted products), donated or recycled goods such as clothing or electronics, or the like. Any good or service which could be considered more environmentally friendly, even if only marginally so, than its standard or common competitive good or service, shall be considered environmentally-conscious for embodiments of the present invention.

The merchants 430 may utilize a general purpose computer system or similar electronic device for communicating with consumers 420 through the network 410. Often, the merchants 430 may additionally use a hosted website or electronic data portal through which consumers 420 may view and evaluate the merchants' goods or services, and subsequently purchase the same. In many embodiments, the merchants 430 utilize respective privately-controlled websites, for example, common retail websites such as Walmart.com or the like. In other embodiments, the merchants 430 utilize use a collective merchant forum available through the network 410, for example, similar to the commercially available Yahoo! shopping website.

In yet alternative embodiments, the merchants 430 utilize an exclusive and privately-controlled forum from which to communicate with consumers 420 through the network 410. In such alternative embodiments, the privately-controlled forum may be regulated by the administrator 440, and access is only allowed to consumers 420 and merchants 430 within the marketplace system 400. In one embodiment, the products and services offered by the merchants 1430 within the marketplace system 400 may be purchased using a credit, or other value, often granted by the administrator, from the customers 420. Other alternative mediums and forums from which the merchants 430 may also exist in various embodiments.

Whereby the system 400 encourages environmentally-conscious behavior and utilizing used, rented or reusable goods constitutes environmentally-conscious behavior, merchants 430 and consumers 420 of various embodiments of the present invention may be interchangeable or may comprise the same individual or entity. For example, in one embodiment, a consumer may purchase an environmentally-conscious product from a merchant within the system 400. Once the consumer has used the product for whatever purpose, the consumer may wish to re-sell, donate, or barter the product to another consumer. In such an instance, the consumer may utilize a public auction system (e.g., eBay) and may sell the product to another consumer through the network 410—which, by definition of the present application, renders such consumer a merchant.

Similarly, in the ordinary course of business, a retailer merchant may be receiving its retail environmentally-conscious goods from a wholesaler, who also happens to be a merchant within the system 400. In this instance, the retailer merchant would be a consumer for the transaction.

In various embodiments, as the marketplace system 400 progresses and adapts to the life cycle of products, the role of merchants 430 and consumers 420 may evolve as well. For example, and in no way limiting the scope of the present invention, consider the life cycle of a cell phone. Perhaps in a first transaction, a consumer purchases a refurbished cell phone from a wireless service provider (e.g., AT&T). After a certain period of time, the consumer may feel the cell phone is outdated and desires a new one. In the marketplace system 400, rather than disposing of the cell phone as waste, or even recycling the components of the cell phone (although considered environmentally-conscious behavior, it also requires dismantling and destruction of several components of the cell phone), the consumer may donate the cell phone to a local charity, or other consumer, who may subsequently obtain software upgrades, chip replacement or other enhanced modification to make the cell phone compatible with modern technology features and extend the life cycle of the product. In such an instance, a consumer to consumer transaction works in a similar fashion as a merchant to consumer transaction. As discussed in more detail below, a consumer to consumer transaction may allow both consumers to receive a credit value for the transaction from the administrator 440.

As contemplated by various embodiments of the present invention, the administrator 440 may comprise any organization or entity administering, monitoring, and/or regulating transactions between consumers and merchants within the system 100. In many embodiments, the administrator 440 comprises a database 450 or other data management system suitable for embodiments of the present invention. In many embodiments, the database 450 comprises one of those described in detail in any of the following U.S. patent application Ser. Nos. 11/345,867, 11/854,387, 12/041,454, 12/041,464, 12/189,217, 12/189,217, 12/189,218, 12/200,527, and 12/354,504, the respective disclosures of which are incorporated herein by reference in their entireties. Each of these applications are co-owned with the present application, by RecycleBank LLC (“RecyleBank”) having offices in New York, N.Y. and Philadelphia, Pa., among other locations.

In one embodiment, administrator 440 is an incentive-based environmental loyalty program administrator, similar to the administrator disclosed in detail in U.S. t application Ser. No. 11/854,387, published on Mar. 6, 2008 as United States Patent Application Publication No. 2008/0059970, the disclosure of which is incorporated herein by reference in its entirety.

Although the system 400 is substantially a virtual environment, i.e., network-based, many of the transactions between the consumers 420 and the merchants 430 require tangible environmentally-conscious products to be shipped or otherwise transferred possession from the merchants 430 to the consumers 420. In many embodiments, the transfer of possession may occur through a shipping means 460, which may include postal mail (e.g., United States Postal Service), package delivery services (e.g., UPS, FedEx, etc.) or the like. In some embodiments, to further encourage environmentally-conscious behavior, the shipping means 460 may comprise the use of an eco-friendly services, for example, the use of hybrid trucks, bio-fuel powered vehicles, shipping boxes from recycled materials, or the like. In alternative embodiments, the goods may be picked-up in person, for example at the residence of another consumer, the business location of a merchant, or some other agreed upon physical location.

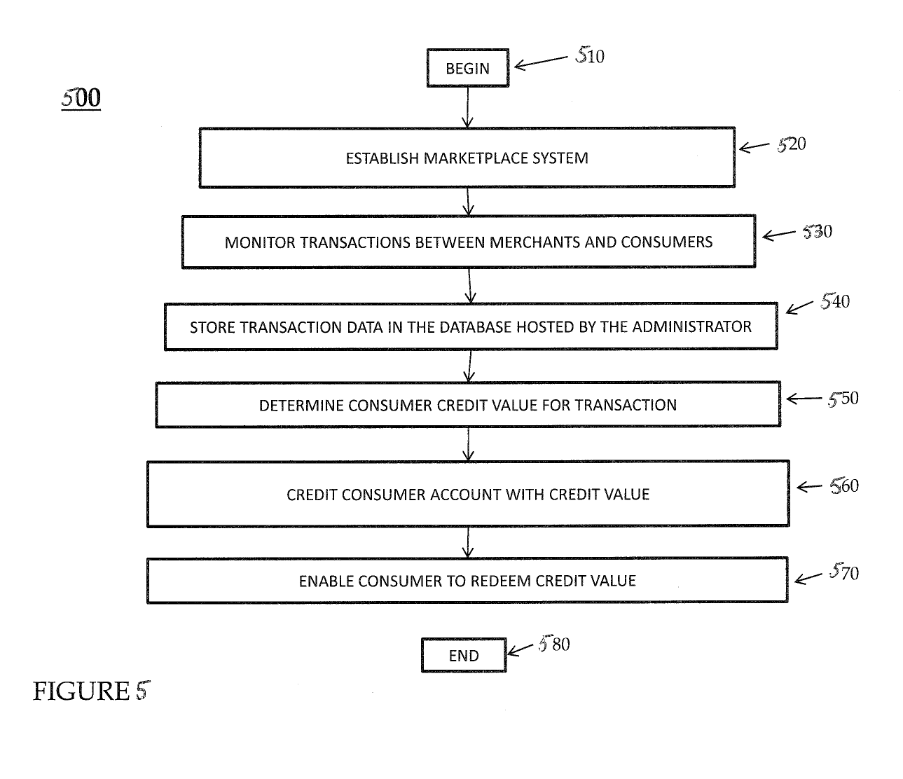

The system 400 may be utilized in efforts to maximize waste reduction and minimize environmental footprints. FIG. 5 depicts a flowchart of an exemplary method in accordance with one embodiment of the present invention. Where applicable, reference is made to the system depicted in FIG. 4 and the computer system in FIG. 2.

The method 500 begins at step 510. At step 520, a system 400 is established by defining a plurality of consumers 420 and a plurality of merchants 430 in communication with one another through a network 410. An administrator 440 comprises a database 450 for storing data records of each of the merchants 430, consumers 420 and other parties within the system 400.

At step 530, the administrator 440 monitors a transaction between merchant and a consumer involving an environmentally-conscious product. As discussed supra, the transaction may comprise the purchase or rent/lease of a recycled, recyclable, used or re-usable product, or a product with minimal or biodegradable packaging. At step 540, the administrator 440 stores data regarding the transaction in the database 450.

In accordance with embodiments of the present invention, software within the database 450 comprises executable instructions for determining a credit value associated with the transaction. As explained in detail in the commonly-owned co-pending US patent applications and patent application publications listed above, the credit value may be determined using any number of techniques, including the mathematical algorithms as described in the applications.

At step 560, the administrator 440 credits the consumer's account with the credit value on the database 450. At step 570, the administrator 440 enables the consumer to redeem the credit value for any of a number of incentivized rewards. A detailed explanation of a multitude of reward redemption and credit accumulation methods are provided in the plurality of commonly-owned co-pending US patent applications and patent application publications listed above. As such, no further explanation is provided here.

The exemplary method 500 ends at step 580.

Various alternative embodiments to those disclosed herein exist, and may often comprise another layer or echelon of environmentally-conscious behavior and activity. For example, in one embodiment, consumers 420 who purchase items may sign-up through the administrator 440 for electronic notifications, whereby other members (consumers or merchants) in the marketplace system 400 will be able to, at anytime, provide that consumer an offer to buy the product they previously purchased. In other words, re-use of goods is promoted by allowing owners to always know the resale/“junk” value of a product, and allowing an opportunity to put the product in someone else's possession and extend its useful life cycle.

As understood by embodiments of the present invention, the marketplace system 400 is designed to provide incentives to consumers 420 to engage in environmentally conscious decisions in all aspects of life. While the disclosure herein discusses particular examples, it is understood to encompass all aspects of eco-friendly and environmentally-conscious behavior. The systems and methods provided herein may be altered or used in conjunction with any of components of the methods and systems of the incorporated-by-reference commonly-owned, co-pending patent applications.

Embodiments of the present invention may be utilized in connection with promoting conservation of any resource, as described hereinabove. It is further contemplated that one or more instances of one or more embodiments of the present invention may be combined together or integrated. While the foregoing is directed to embodiments of the present invention, other and further embodiments of the invention may be devised without departing from the basic scope thereof.

What is claimed is:

1. A method for administering an incentive-based program to encourage environmentally-conscious behavior comprising:
providing a network-accessible database, hosted by an administrator, having a plurality of sets of records, each set of records corresponding to a user;
monitoring an environmentally-conscious behavioral activity of a first user, and recording a record of the behavioral activity in the database;
using a computer-based mathematical calculation to translate the record of the behavioral activity to a value, and storing the value within a record of a set of records corresponding to the first user; and
allowing the first user to access the database, using a computing device to communicate through a data portal to the database via a network, to redeem the value for a credit at a third party retailer.

2. The method of claim 1, wherein a plurality of different environmentally-conscious behavioral activities are monitored, a record each of the plurality of different environmentally-conscious behavioral activities are translated to a value, and the first user is permitted to redeem a cumulative value from each value for a credit at a third party retailer.

3. The method of claim 1, wherein the environmentally-conscious behavioral activity comprises at least one of engaging in a reduction in energy consumption, a reduction in water consumption, a reduction of waste production, an increase in recycling activity, the utilization of a reusable product, or an expansion of a life cycle of a product.

4. The method of claim 1, wherein the environmentally-conscious behavioral activity is monitored over a predetermined time interval.

5. The method of claim 4, wherein the computer-based mathematical calculation utilizes a comparison of the record of the environmentally-conscious behavior activity over the predetermined time interval and a predetermined limit.

6. The method of claim 5, wherein the predetermined limit comprises at least one of a suggested value by a government agency, a relevant measurement from the first user over a substantially similar predetermined time interval, or an average value from a plurality of users within a community.

7. The method of claim 1, wherein monitoring the environmentally-conscious behavioral activity of the first user comprises utilizing a quantitative measuring apparatus, capable of monitoring the first user's usage or consumption of a resource.

8. The method of claim 7, wherein the measuring device comprises one of an industry-standard energy meter or an industry-standard flow meter.

9. The method of claim 7, wherein the quantitative measuring apparatus further comprises a reporting means for providing a measurement to the administrator.

10. A method of administering an incentive-based utility conservation program comprising:
monitoring a first entity's utility usage data over a predetermined time interval using a measuring and recording means, and reporting the utility usage data to an administrator;
comparing utility usage data to a predetermined limit;
determining whether the utility usage data satisfied the predetermined limit, and subsequently converting the utility usage data to a value; and
storing the value in a database record, the database record comprising a cumulative value of values accumulated by the first entity;
permitting the first entity to access a data portal through a network, using a computing device, to redeem the value for a credit at a third party participating retailer;
wherein the cumulative value comprises a plurality of values, each value acquired by the first entity through a plurality of environmentally-conscious behavioral activities.

11. The method of claim 10, wherein the each of the plurality of environmentally-conscious behavioral activity comprises at least one of engaging in: a reduction in energy consumption, a reduction in water consumption, a reduction of waste production, an increase in recycling activity, the utilization of a reusable product, or an expansion of a life cycle of a product.

12. The method of claim 10, wherein the cumulative value comprises at least a value acquired from a reduction in the first entity's utility consumption and a value acquired from the first entity's recycling habits.

13. The method of claim 10, wherein the predetermined limit comprises at least one of a suggested value by a government agency, a relevant measurement from the first user over a substantially similar predetermined time interval, or an average value from a plurality of users within a community.

14. The method of claim 10, wherein monitoring the environmentally-conscious behavioral activity of the first user comprises utilizing a quantitative measuring apparatus, capable of monitoring the first user's usage or consumption of a resource.

15. The method of claim 14, wherein the measuring device comprises one of an industry-standard energy meter or an industry-standard flow meter.

16. The method of claim 14, wherein the quantitative measuring apparatus further comprises a reporting means for providing a measurement to the administrator.

17. The method of claim 16, wherein the reporting means comprises scraping data from a database hosted by a utility provider.

18. A method for administering an incentive-based program to encourage environmentally-conscious behavior comprising:
establishing a marketplace system, the marketplace system comprising:
a computer accessible network;
a plurality of consumers;
a plurality of merchants; and
an administrator, having a database in communication with the network for overseeing transactions between any one of the plurality of consumers and any one of the plurality merchants;
monitoring a commercial transaction between a first consumer of the plurality of consumers and one of the plurality merchants;
storing data regarding the transaction in the database;
using a computer-based mathematical calculation to translate the data to a value, and storing the value within a record in the database corresponding to the first consumer; and
allowing the first consumer to access the database, using a computing device to communicate through a data portal to the database via the computer accessible network, to redeem the value for a credit at a third party retailer;
wherein the commercial transaction comprises an environmentally-conscious behavioral activity.

19. The method of claim 18, wherein the record in the database corresponding to the first consumer comprises a cumulative value of values accumulated by the first consumer.

20. The method of claim 19, wherein the cumulative value comprises a plurality of values, each value acquired by the first entity through a plurality of different environmentally-conscious behavioral activities.
